(19) United States
(12) Patent Application Publication
(10) Pub. No.: US 2026/0104742 A1
(43) Pub. Date: Apr. 16, 2026

(54) Hinged Device

(71) Applicant: Microsoft Technology Licensing, LLC, Redmond, WA (US)

(72) Inventors: Denys V. YAREMENKO, Carnation, WA (US); Brett A. TOMKY, Seattle, WA (US); Nicholas WENDT, Seattle, WA (US); Devin CAPLOW-MUNRO, Seattle, WA (US)

(73) Assignee: Microsoft Technology Licensing, LLC, Redmond, WA (US)

(21) Appl. No.: 18/916,377

(22) Filed: Oct. 15, 2024

(51) Int. Cl. G06F 1/16; F16C 11/04

(52) U.S. Cl. CPC G06F 1/1681; F16C 11/04

(57) ABSTRACT

The description relates to hinged devices, such as hinged computing devices that include a pop-up function. One example can include a first portion and a second portion that are rotatably secured through a range of rotation from an open orientation to a closed orientation. This example can also include a selective isolation assembly configured to convert rotational torque associated with rotating the first and second portions toward the closed orientation to a compressive force that compresses a spring. The selective isolation assembly is configured to disconnect the first and second portions and the compressed spring as the first and second portions approach the closed orientation.

### BACKGROUND

Many computer form factors such as smart phones, tablets, and notebook computers can provide enhanced functionality by folding for storage and opening for use. For instance, the folded device is easier to carry and the opened device offers more input/output area. Many hinge designs have been tried for folding the device portions.

### SUMMARY

This patent relates to hinged devices, such as hinged computing devices that include a pop-up function. One example can include a first portion and a second portion that are rotatably secured through a range of rotation from an open orientation to a closed orientation. This example can also include a selective isolation assembly configured to convert rotational torque associated with rotating the first and second portions toward the closed orientation to a compressive force that compresses a spring. The selective isolation assembly is configured to disconnect the first and second portions and the compressed spring as the first and second portions approach the closed orientation.

This example is intended to provide a summary of some of the described concepts and is not intended to be inclusive or limiting.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced. Where space permits, elements and their associated reference numbers are both shown on the drawing page for the reader's convenience. Otherwise, only the reference numbers are shown. Note that some figures illustrate many elements and adding lead lines to all of the elements can diminish readability of the figure. Accordingly, not every element is designated in every figure. In some figures, where similar elements appear twice on the figure, such as on the left side and the right side, some elements are labeled on one side, but not both sides to avoid clutter on the drawing page.

FIGS. 1A-1G, 3A-3E, 4A, and 4B show perspective views of example devices in accordance with some implementations of the present concepts.

FIGS. 2 and 4C-4M show elevational views of example devices in accordance with some implementations of the present concepts.

### DESCRIPTION

The present concepts relate to devices, such as computing devices employing hinge assemblies that can rotationally secure/couple first and second device portions. The hinged configuration can allow the user to open the device and expose displays during use and close the device to protect the displays and reduce device size when not in use. The user reopens the device when they want to use it again. In some cases, especially with relatively thin devices, it can be difficult for the user to grasp the device portions and pull them open from the closed orientation. As such, energy can be stored in the device as it is closed, and this energy can be released to facilitate the opening process (e.g., pop-up).

However, traditional pop-up designs continuously impart the pop-up force on the first and second portions when the device is in the closed orientation. As such, these traditional designs require locks at the distal ends of the first and second portions that lock the first and second portions together against the pop-up force until the lock is opened. These traditional designs create undesired forces on the first and second portions that can result in bending of the first and second portions and/or failure of device components from fatigue.

The present concepts provide a technical solution to these technical problems by disconnecting the pop-up force from the first and second portions until the user desires to open the device. Stated another way, the present concepts can isolate the pop-up forces in the hinge assembly until releasing them to act on the first and second portions when opening is desired. These and other aspects are described in more detail below by way of example.

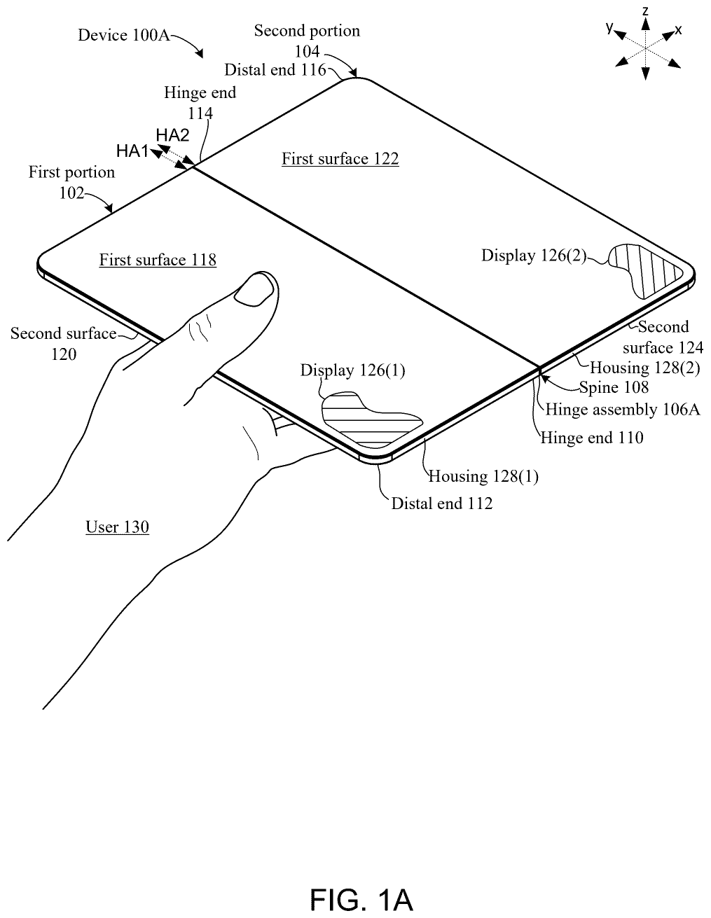

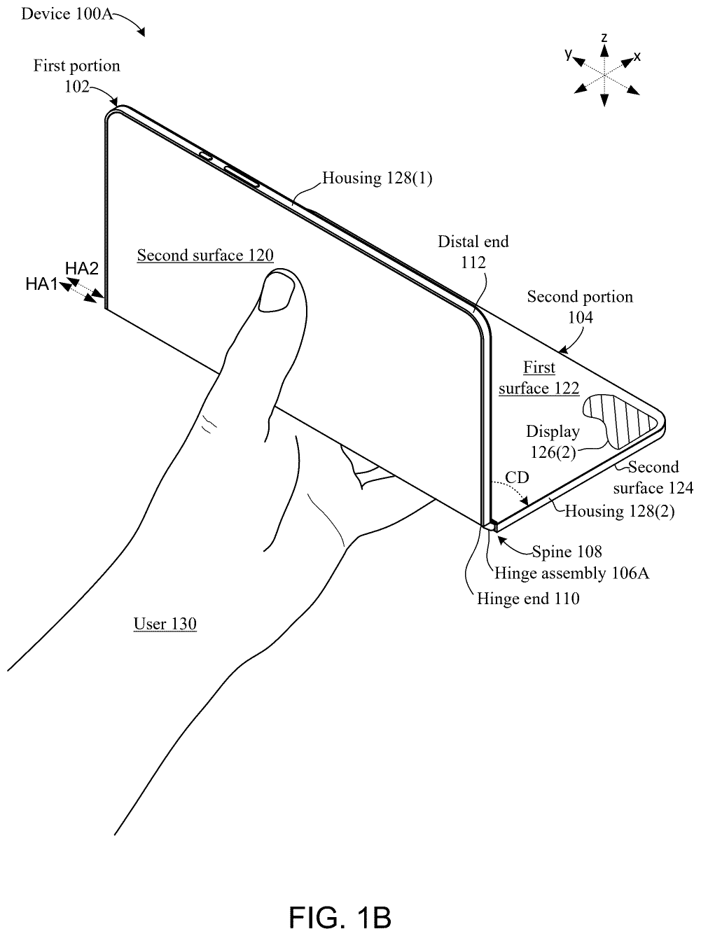

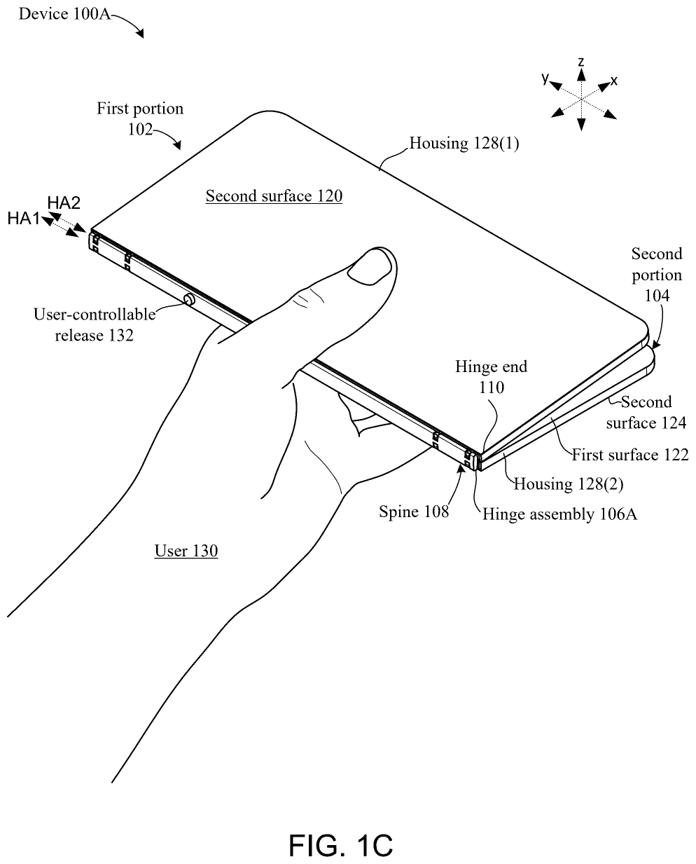

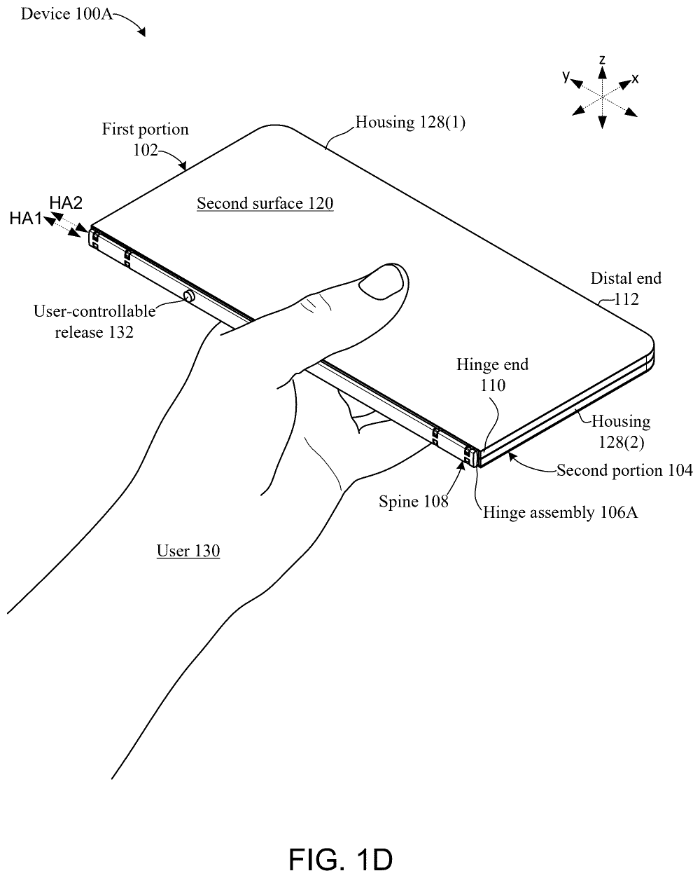

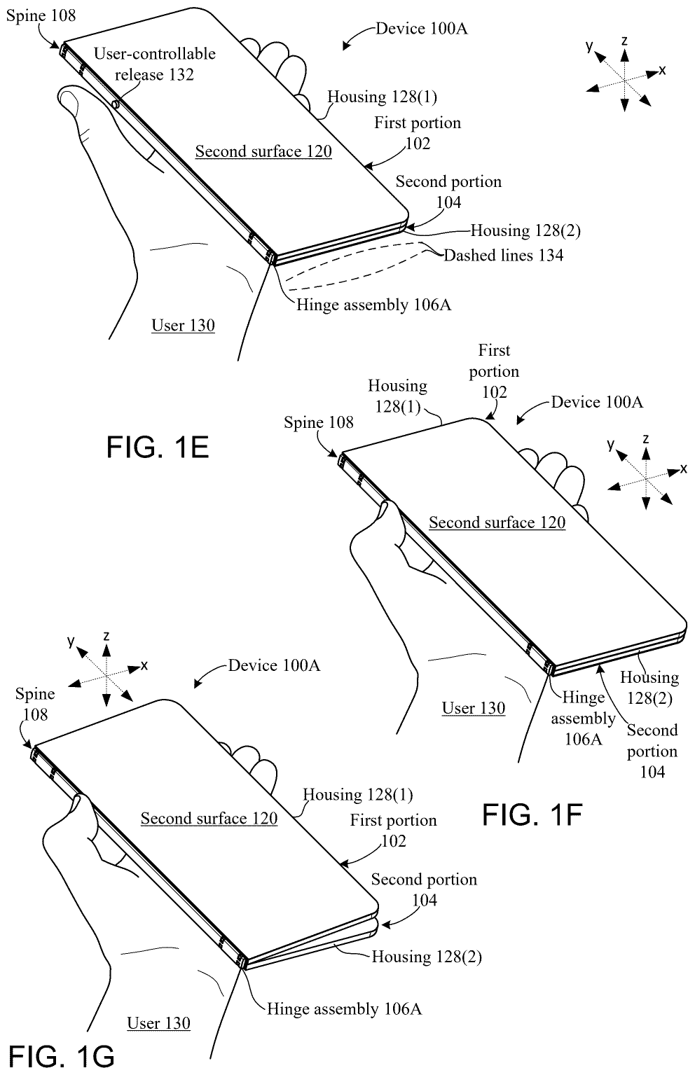

Introductory FIGS. 1A-1G collectively show an example device 100A that has first and second portions 102 and 104 that are rotatably secured together by a hinge assembly 106A positioned in a spine 108. The hinge assembly 106A can rotatably secure the first and second portions through a range of orientations including a closed orientation and various open orientations. (The use of the alphabetic suffixes ‘A,’ ‘B,’ etc. relative to the device 100 and the hinge assembly 106 indicate that multiple different device form factors and multiple different hinge assembly form factors are described.)

The first portion 102 can extend from a hinge end 110 to a distal end 112. The second portion 104 also can extend from a hinge end 114 to a distal end 116. In this implementation, the hinge assembly 106A can define two hinge axes HA. The first portion 102 can rotate around first hinge axis HA1 and the second portion 104 can rotate around second hinge axis HA2.

The first portion 102 can include opposing first and second major surfaces 118 and 120 (hereinafter, first and second surfaces). Similarly, the second portion 104 can include opposing first and second major surfaces 122 and 124 (hereinafter, first and second surfaces).

In some implementations, displays 126 are supported by housings 128. For example, the displays 126 can be positioned on the first and/or second surfaces 118, 120, 122, and/or 124, respectively. In the illustrated configuration, the displays 126 are positioned on first surfaces 118 and 122, respectively.

FIG. 1A shows user 130 holding the device 100A at a 180-degree orientation (e.g., the first and second portions 102 and 104 define a 180-degree angle). FIG. 1B shows the user's thumb and fingers decreasing (e.g., rotating toward closed) the orientation to 90 degrees. FIG. 1C shows the user's thumb and fingers continuing to decrease the orientation to about five degrees. FIG. 1D shows the user rotating the device portions to a closed orientation (e.g., the angle between the first and second portions is about zero). In this implementation, the 180-degree orientation of FIG. 1A represents a fully open orientation. However, other implementations can have a fully open orientation that is less than or more than 180 degrees. Similarly, in this implementation, the closed orientation of FIG. 1D is zero degrees. Other implementations can have a closed orientation that is slightly greater or less than zero degrees, such as in a range from +five degrees to −five degrees.

During this closing rotation shown from FIGS. 1A-1D, the user exerts a force on the first and second portions 102 and 104 to rotate them toward one another (e.g., in the closing direction as indicated by arrow CD in FIG. 1B) to decrease the relative angle defined between the first and second portions. The hinge assembly 106A can store some of this force as potential energy. The present concepts provide a technical solution where the potential energy is stored in the spine 108 and isolated from the first and second portions 102 and 104. The stored energy can provide an opening force (e.g., a pop-up force) on the first and second portions when the user is ready to open the device 100A to make opening easier for the user. It is noteworthy that the present concepts allow this stored energy to be stored in the spine and to be selectively disconnected or decoupled from the first and second portions 102 and 104 until the user desires to open the device. These aspects are shown in FIG. 1E-1G.

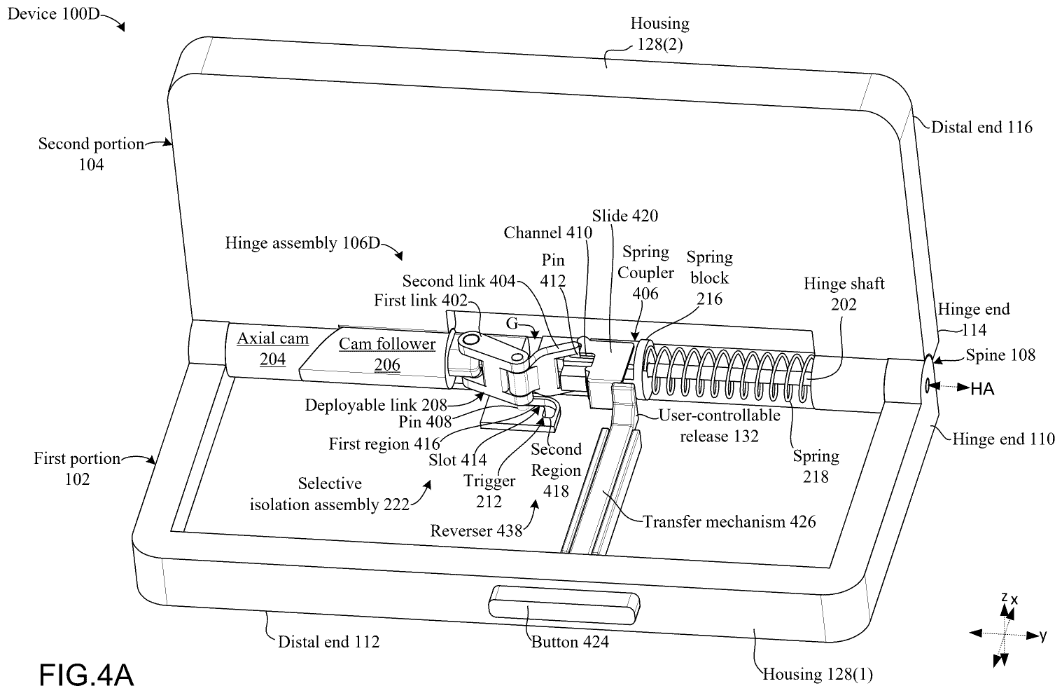

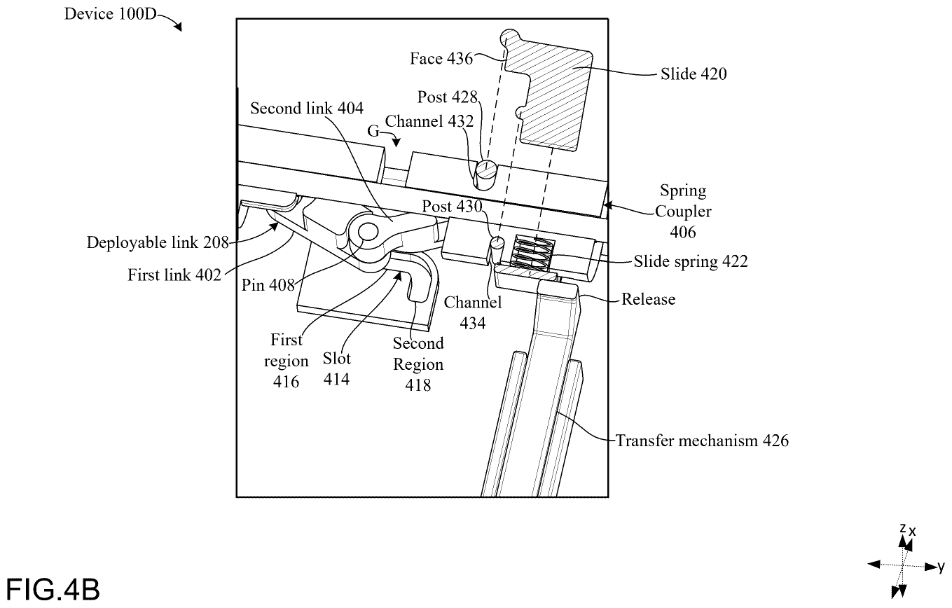

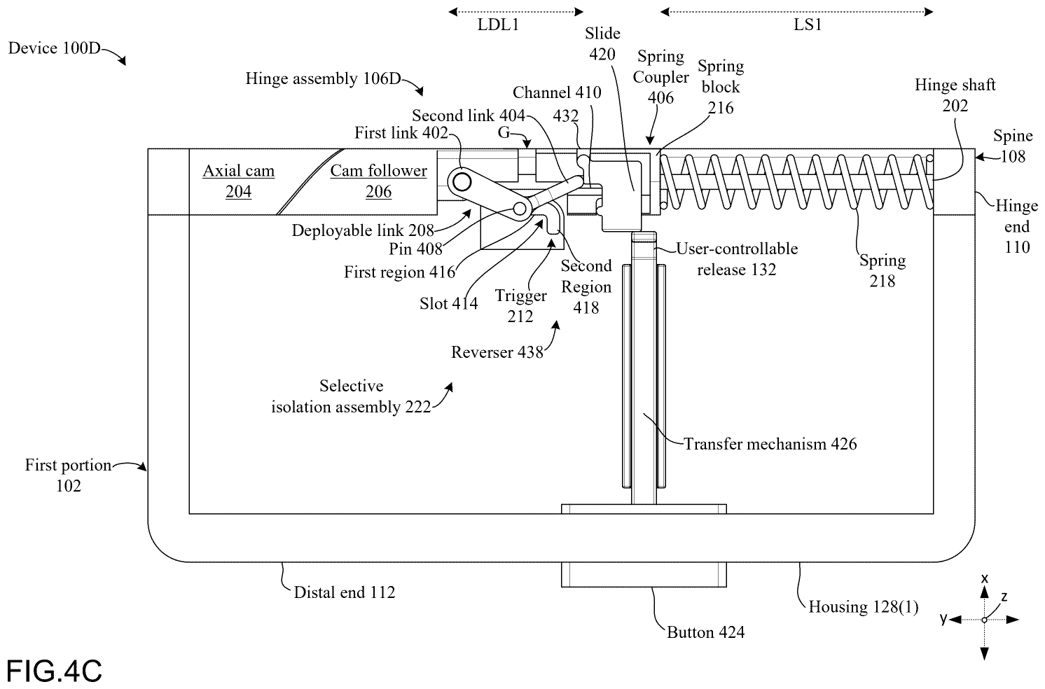

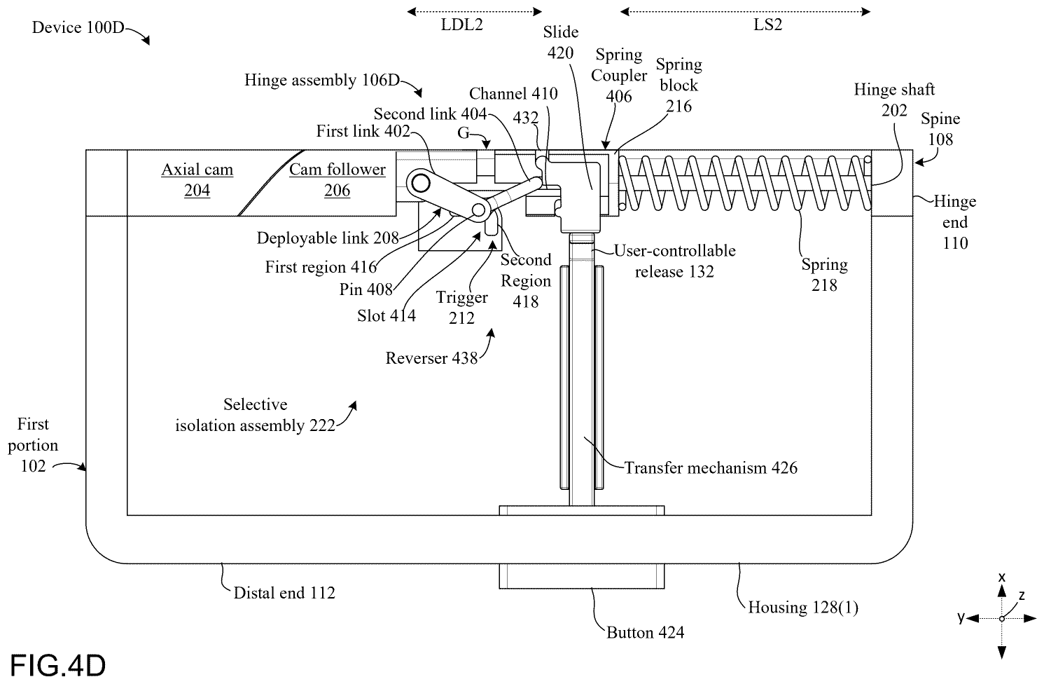

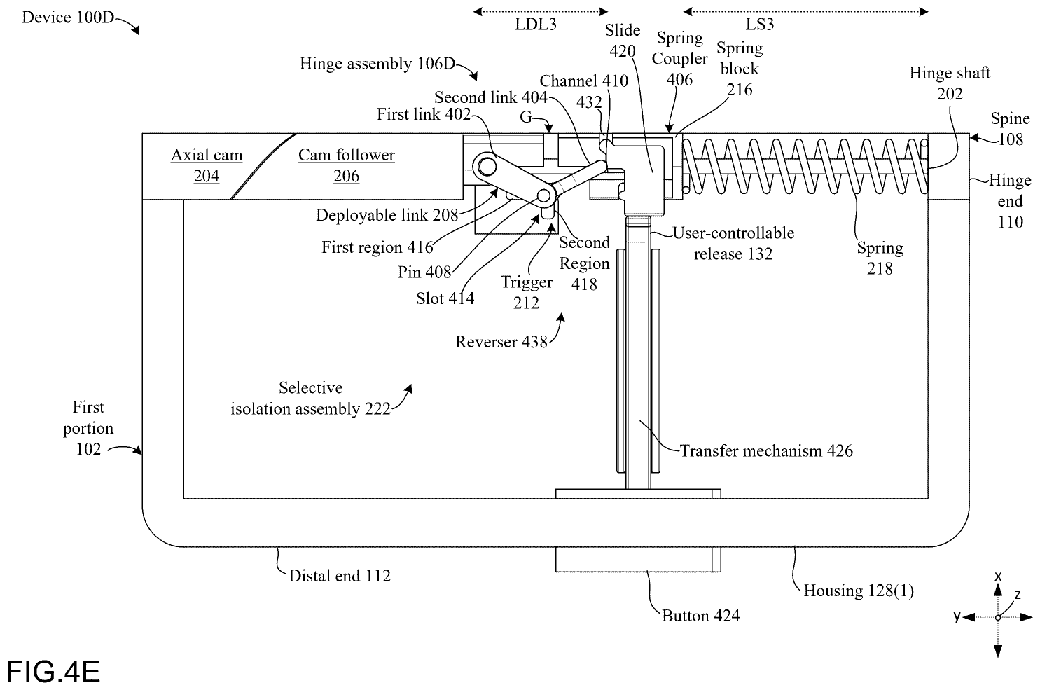

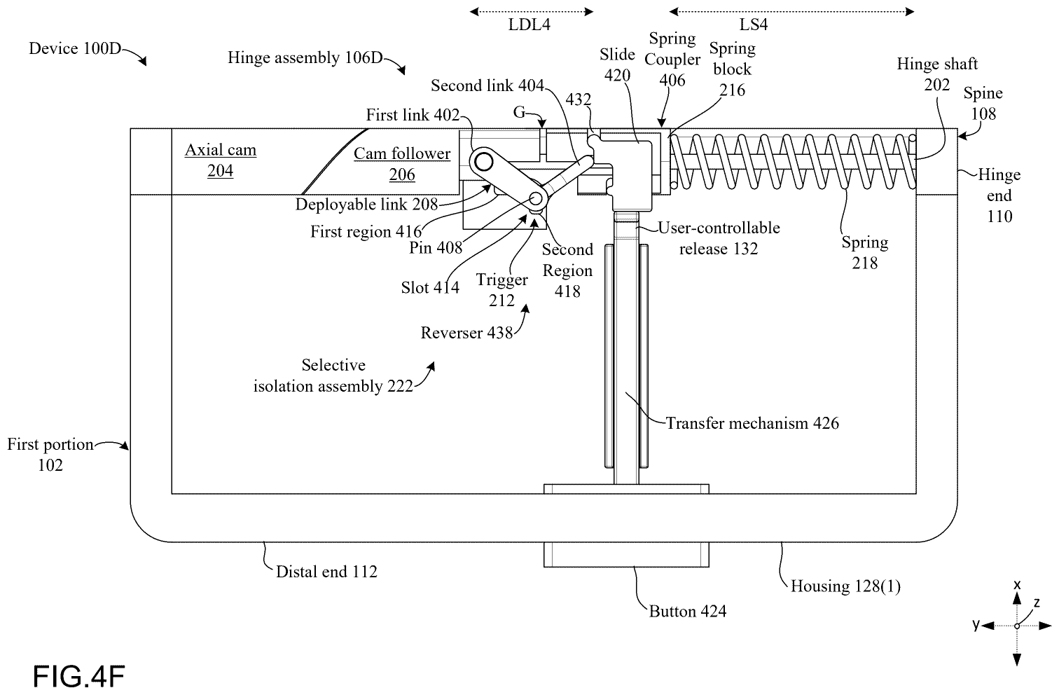

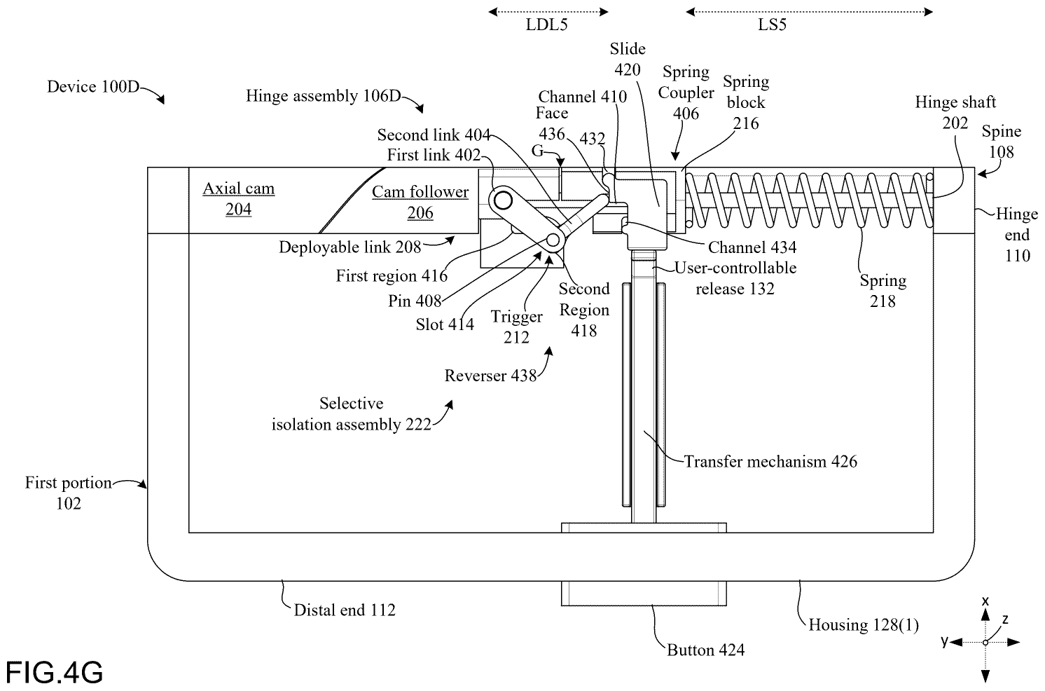

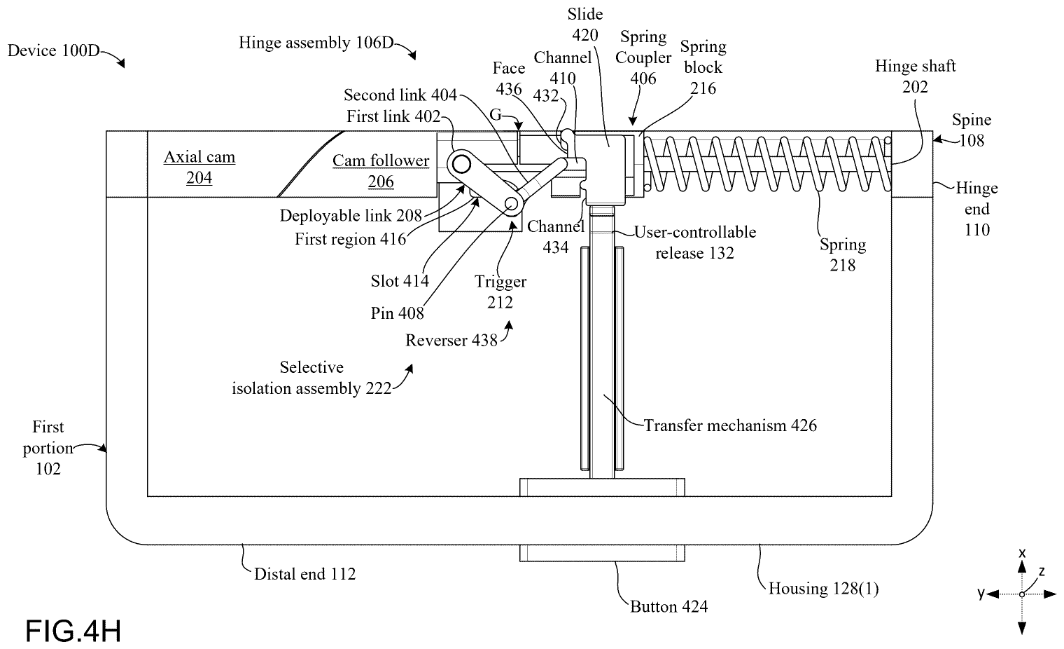

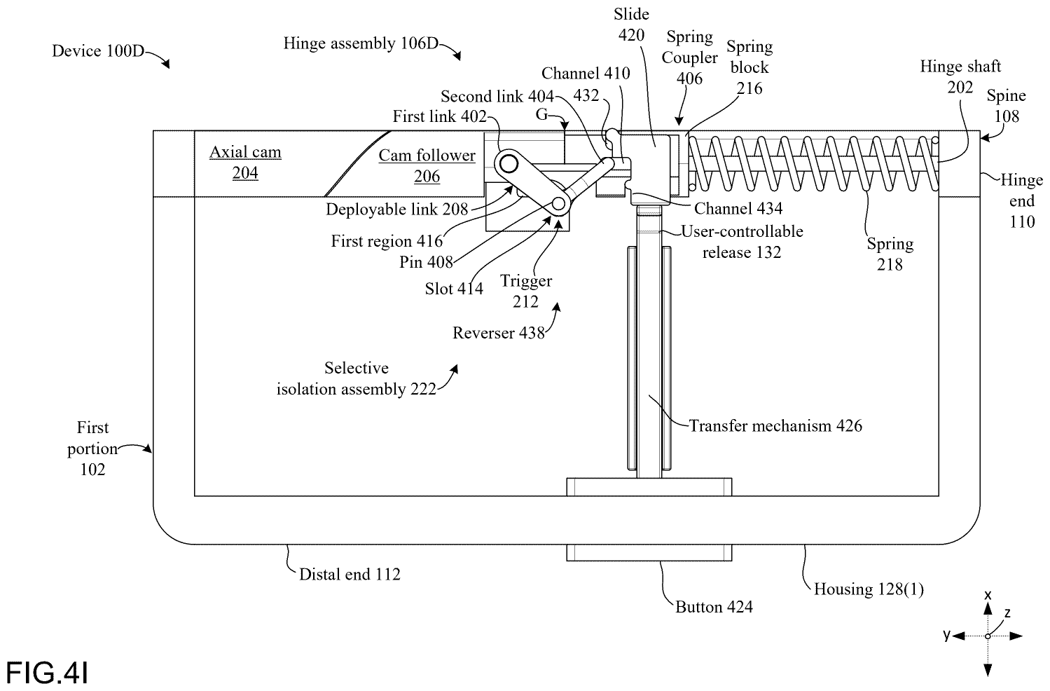

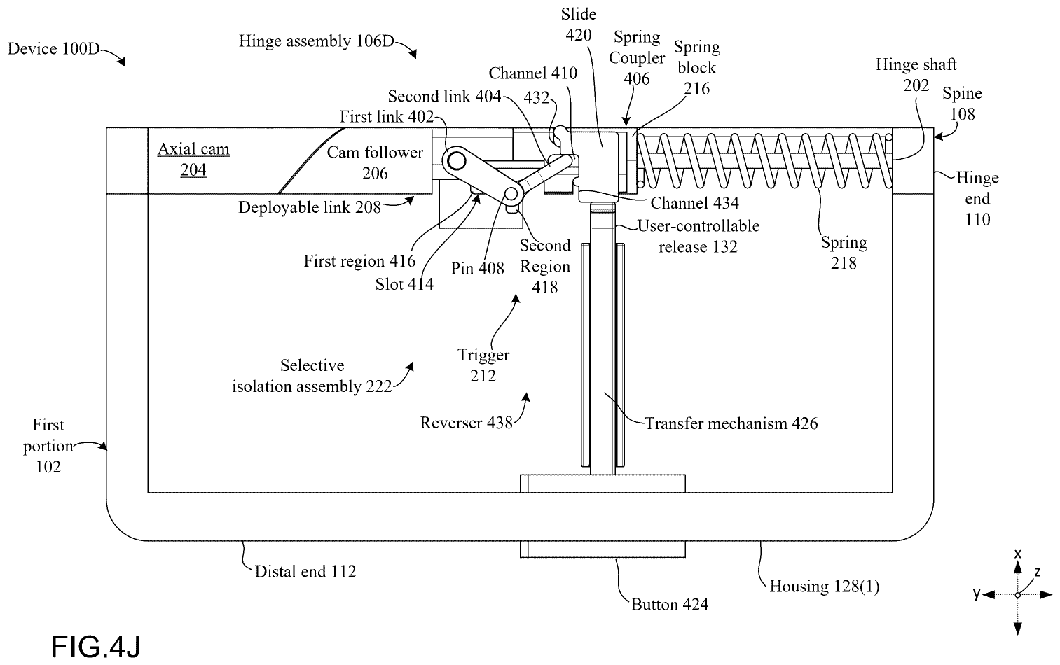

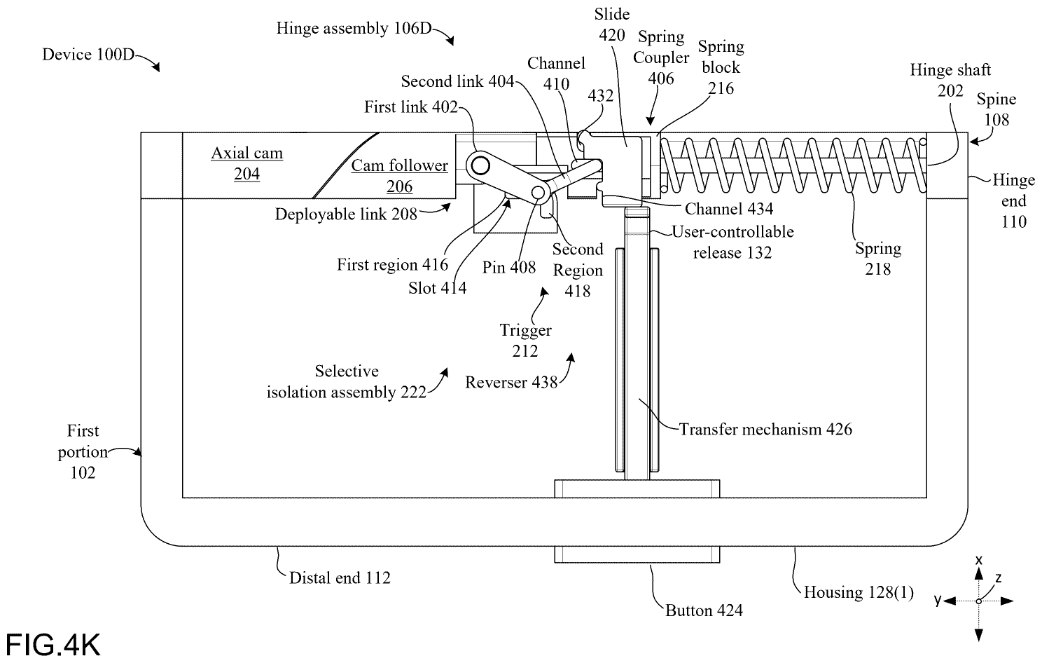

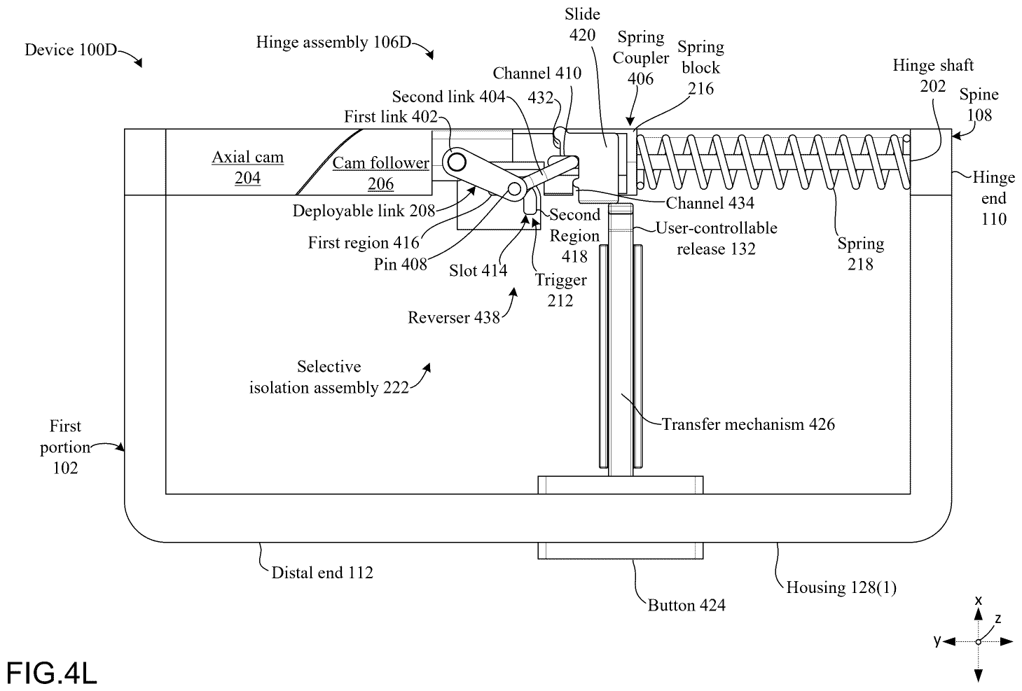

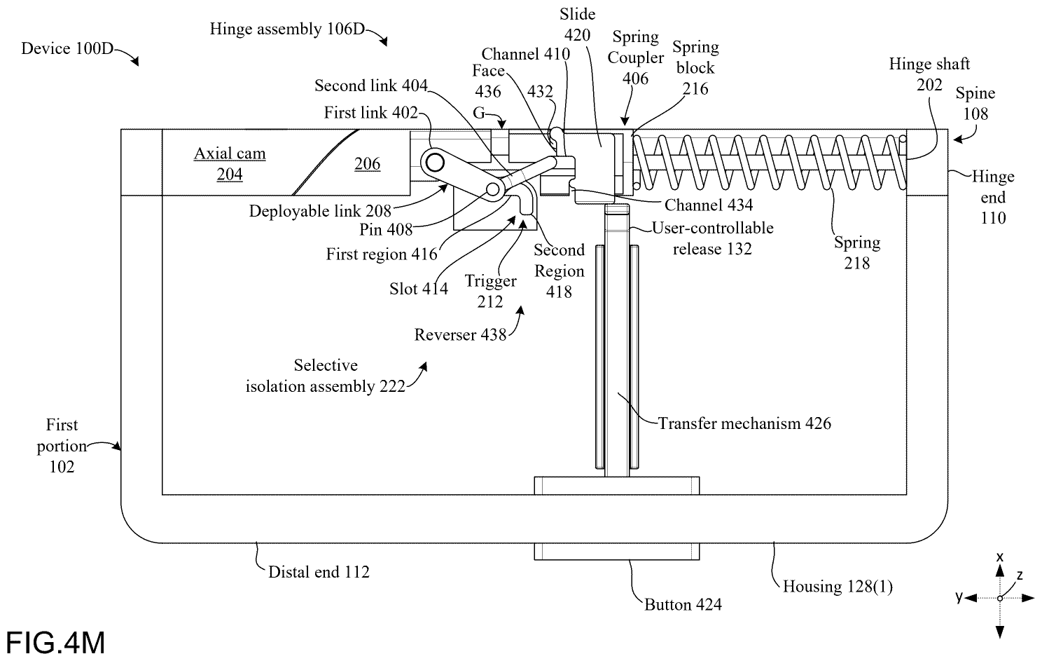

FIGS. 1E-1G collectively show how the user 130 can open the device 100A and how the opening can be augmented with stored pop-up energy. FIG. 1E shows the user's thumb proximate to a user-controllable release (‘release’) 132. In this implementation, the release 132 is located on the spine 108. An alternative configuration is described below relative to FIGS. 4A-4M. The function of the release 132 is to recouple the stored energy to the first and second portions 102 and 104 as a pop-up force. FIG. 1F shows the user activating the release 132 with their thumb and FIG. 1G shows the pop-up force opening the device a few degrees, such as about five or ten degrees, or example. However, in this implementation, the opening force is only (selectively) applied to the first and second portions 102 and 104 when the user wants to open the device and activates the release 132. Until then, the energy is stored in the hinge assembly 106A and is disconnected from the first and second portions. Thus, the release 132 functions as part of a disconnect rather than as a lock. This provides a technical advantage over traditional pop-up hinge designs which must lock the first and second portions together against the pop-up force. Further, as mentioned above, this implementation positions the release 132 on the spine. This provides an additional technical solution because the mechanisms associated with storing and releasing pop-up force are entirely contained in the spine and do not occupy any device real estate in the first and second portions. This technical advantage allows the device real estate in the first and second portions to be dedicated to other components.

With traditional hinge designs, pop-up force is continuously imparted on the first and second portions when the device is closed. A lock holds the distal ends together and prevents the pop-up force from opening the device until unlocked by the user. In these traditional designs, the pop-up force can undesirably operate on the first and second portions and cause bending or bowing of the first and second portions in the xy plane from a planar shape to a curved shape. This phenomenon can be referred to as ‘suitcasing’ as it is analogous to the outward bending or bulging of the sides of an overstuffed suitcase that is forced shut and locked.

An example of suitcasing associated with a traditional pop-up design is illustrated in FIG. 1E by dashed lines 134, which represent the bowed first and second portions of a traditional design where the pop-up force continually acts on the first and second portions when the device is closed and locked at the distal ends. Suitcasing or other deforming of the housing 128 is undesirable for multiple reasons. For instance, traditional designs produce suitcasing and/or require the structural aspects of the housing to be enhanced to resist bending in the z direction. Suitcasing can cause failure of the devices, such as failure of the displays 126 and/or connections to the displays due to flexing, bending and/or component and/or connector fatigue. Increasing the robustness of the housing to decrease suitcasing increases costs and/or dimensions (e.g., thickness) of the device, and/or decreases device real estate for other components because the housing occupies more of the internal volume.

The present concepts provide a technical solution to these technical problems by disconnecting the pop-up force from the first and second portions 102 and 104 until the user wants to open the device 100A and releases the pop-up force to act on the first and second portions. Stated another way, the pop-up force is stored in the hinge assembly 106A and does not act on (e.g., is disconnected/decoupled from) the first and second portions 102 and 104 until released by the user. This technical solution avoids the bulging of traditional pop-up devices (e.g., the first and second portions remain planar in the xy reference plane) when the pop-up force is stored in the hinge assembly and not connected to the first and second portions.

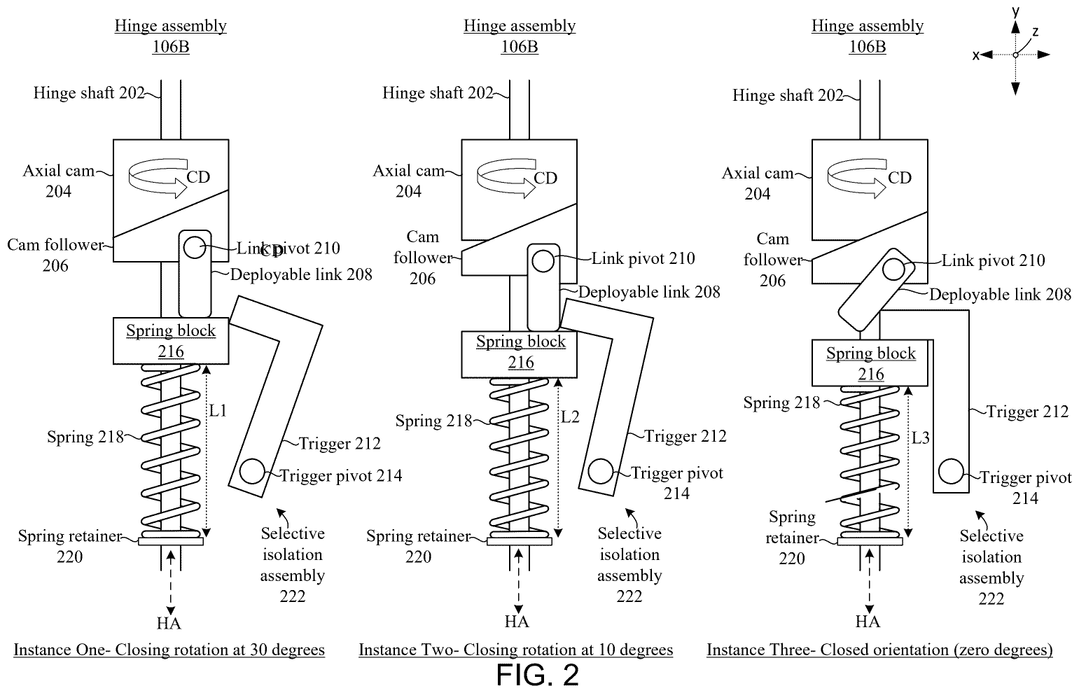

While some of the present implementations may employ a lock, the technical solutions also avoid the need to lock the first and second portions 102 and 104 together to counter the pop-up force because the pop-up force is not applied to the first and second portions until the user wants them to rotate open and they are free to rotate at that point. Instead, the technical solutions isolate the pop-up force in the hinge assembly 106A until released by the user. Thus, a lock is not required to hold the first and second portions together in the closed orientation (e.g., to counter the pop-up force) because the pop-up force is not acting on the first and second portions until it is selectively applied to open the device. Example mechanisms for achieving the pop-up force disconnect are described below relative to FIGS. 2-4M.

FIG. 2 shows an example hinge assembly 106B. This hinge assembly 106B defines hinge axis HA. This hinge assembly includes a hinge shaft 202, an axial cam 204, a cam follower 206, a deployable link 208, a link pivot 210, a trigger 212, a trigger pivot 214, a spring block 216, a spring 218, and a spring retainer 220. The deployable link 208, trigger 212, and spring block 216 collectively function as a selective isolation assembly 222. The selective isolation assembly 222 is a technical solution that provides the pop-up force disconnect function introduced above. This technical solution isolates the pop-up force in the spine until it is desired to be applied to the first and second portions to open the device.

The hinge shaft 202 is positioned in the spine and is secured to the first portion (not shown in this view) so that rotation of the first portion causes rotation of the hinge shaft and, conversely, rotation of the hinge shaft causes rotation of the first portion. The axial cam 204 is secured around the hinge shaft (e.g. coaxial with the hinge shaft relative to the hinge axis HA). The cam follower 206 is positioned around the hinge shaft 202 but does not rotate with the hinge shaft. The cam follower is free to slide along the hinge shaft in the y reference direction (e.g., along the hinge axis). The deployable link 208 is pivotally secured to the cam follower 206 by the link pivot 210. The trigger 212 is pivotally secured in the hinge assembly 106B by the trigger pivot 214. The spring 218 is captive between the spring block 216 and the spring retainer 220. The spring block 216 is positioned on hinge shaft 202. In this implementation, the spring 218 and the hinge shaft 202 are coextensive with the hinge axis. The spring block 216 is free to move along the hinge shaft in the y reference direction. In contrast, the spring retainer 220 is positioned around the hinge shaft 202 at a fixed location (e.g., the spring retainer cannot move along the y reference axis).

For purposes of explanation, assume that in the example of FIG. 2, the user is starting with an open device and wants to close the device. As such, the user is imparting a force on the first and second portions toward one another in the closing direction represented by arrow CD. As shown in Instance One, in operation, as the user imparts the force on the first portion in the closing direction toward the second portion, the axial cam 204 rotates with the hinge shaft 202. In contrast, the cam follower 206 does not rotate. Rotation of the axial cam 204 against the cam follower 206 creates a linear force in the −y direction on the cam follower. Stated another way, the axial cam 204 and cam follower 206 convert the rotational force around the hinge axis into a linear force parallel to the hinge axis.

At the point illustrated in Instance One, the deployable link 208 extends between the cam follower 206 and the spring block 216. The deployable link 208 transfers the linear force (e.g., movement of the cam follower 206) to the spring block 216. In turn, the spring block 216 moves in the −y reference direction and imparts the linear force on the spring 218. At this point, the spring 218 is uncompressed and has a length L1. The spring 218 cannot move downward in the −y reference direction because of the spring retainer 220. Thus, the linear force will begin to compress the spring 218 in the y direction. (Assume the user imparts enough force on the first and second portions so that the linear force imparted on the spring is greater than the opposing spring force and compresses the spring).

Instance Two shows the resulting rotation and compression from about 30 degrees to about 10 degrees. The force imparted by the user on the first and second portions rotated the hinge shaft 202 and the axial cam 204. Rotation of the axial cam 204 pushes the cam follower 206 downward in the −y reference direction. This downward movement is transferred through the deployable link 208 to the spring block 216, which moves downward (e.g., in the −y reference direction) an equal amount. This downward movement of the spring block 216 compresses the spring 218. The compression of the spring 218 is evidenced in that the spring length is now L2, which is less than L1. The compression of the spring 218 stores the rotational force imparted by the user and converted to linear force by the axial cam 204 as potential energy in the spring 218.

Note also in Instance Two that the downward movement of the spring block 216 is now sufficient to allow the trigger 212 to start to ‘ride up’ onto the spring block 216 (e.g., onto the upper horizontal surface that is contacted by the deployable link 208). However, at this point, the deployable link 208 continues to structurally interconnect the cam follower 206 and the spring block 216.

Instance Three shows the device at the closed or zero-degree orientation. At this point continued closing direction rotation of the first and second portions by the user produced closing direction rotation of the axial cam 204 and linear movement of the cam follower 206. The deployable link 208 conveyed/translated the linear movement of the cam follower 206 to the spring block 216. The spring block movement further compressed the spring 218, which is evidenced in that spring length L3 is shorter than spring length L2 of Instance Two. However, at this point, the downward movement of the spring block 216 has allowed the trigger 212 to fully ride up on the spring block 216 and engage the deployable link 208. The trigger 212 has rotated the deployable link 208 (e.g., in the clockwise direction in this case) sufficiently that the deployable link 208 is no longer physically engaging (e.g., touching) the spring block 216. Further, the trigger 212 is physically restraining the spring block 216 from moving in the +y reference direction.

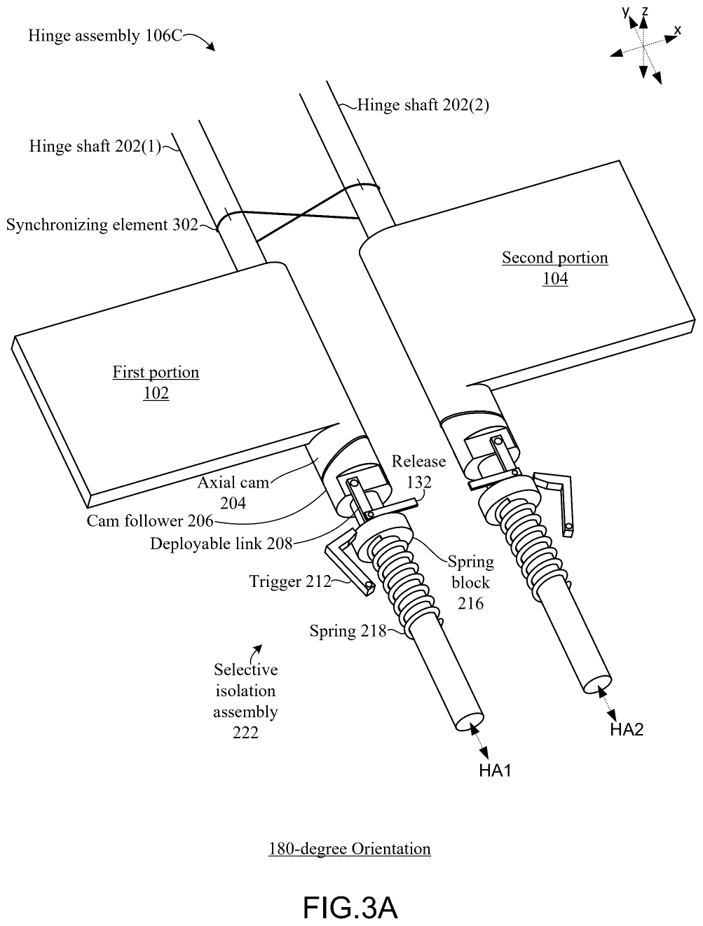

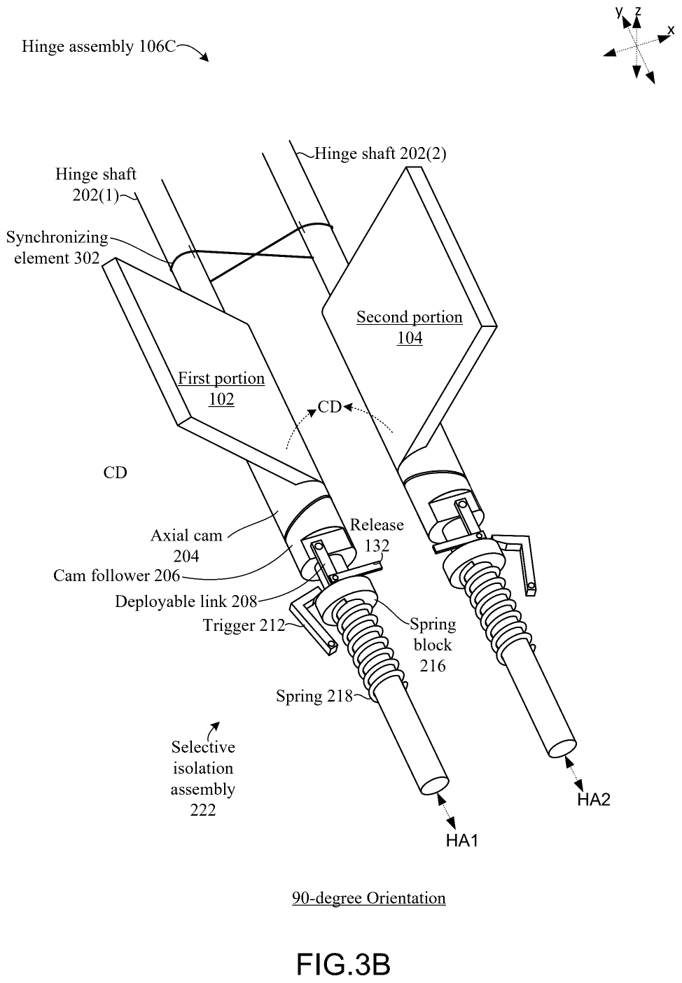

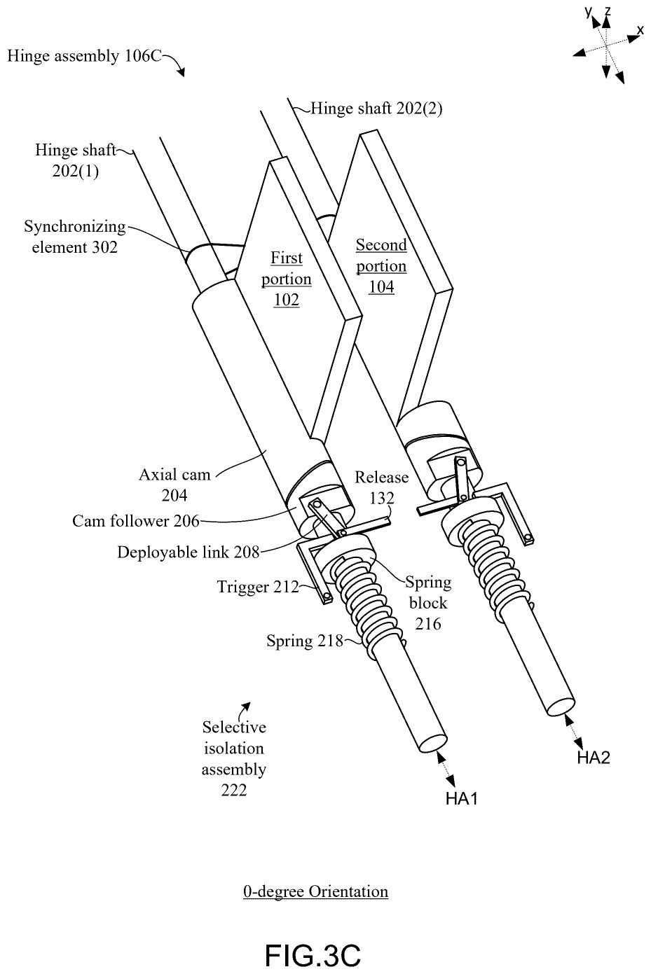

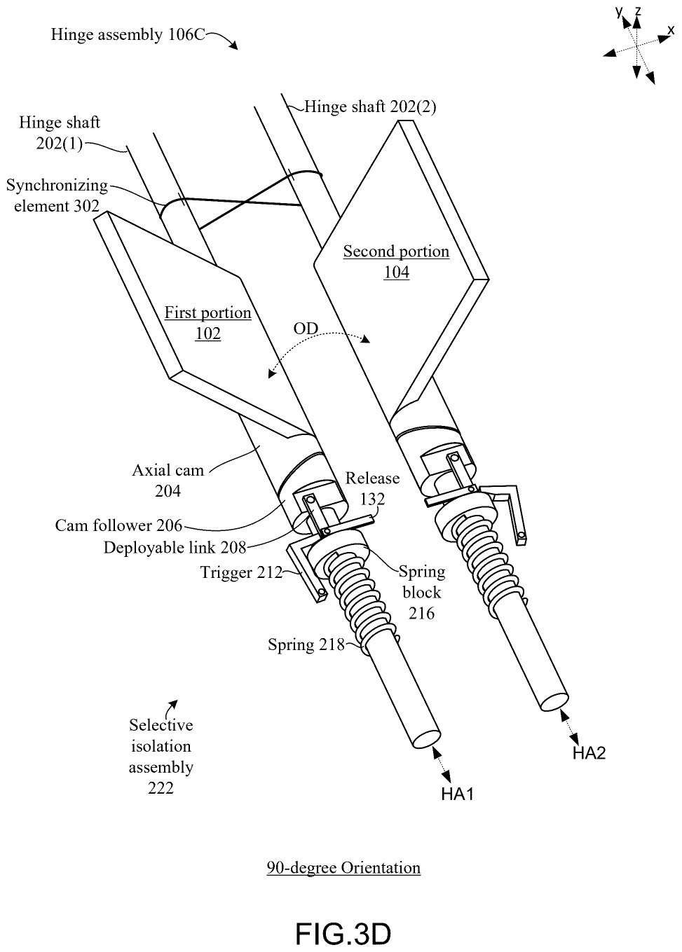

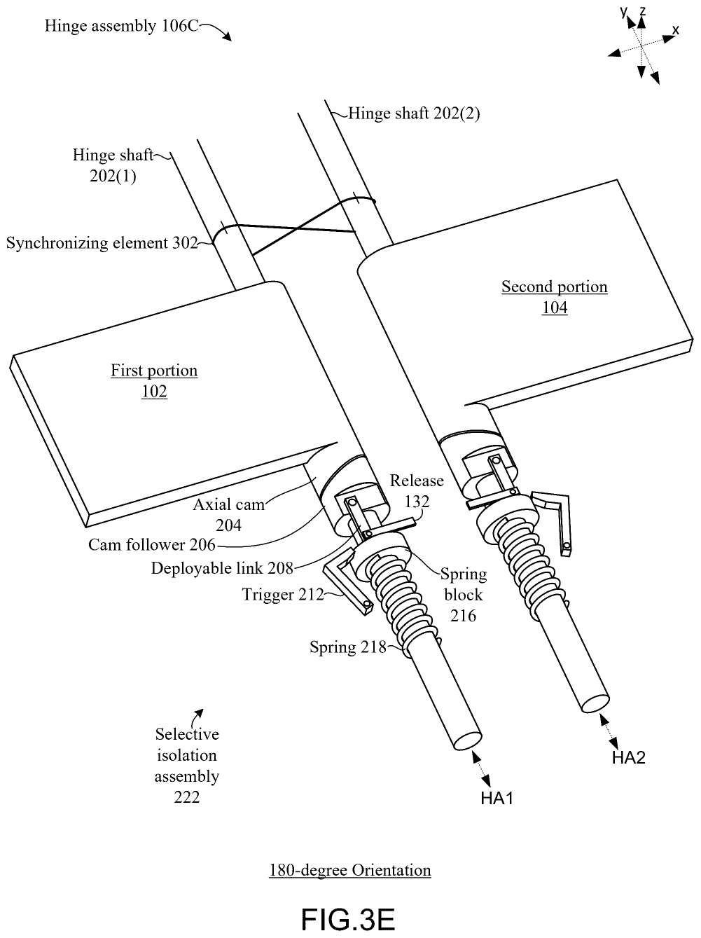

Thus, two technical events are now occurring in Instance Three. First, the spring 216 is creating a force in the +y reference direction (e.g., the spring is compressed and creates a force to return to its original uncompressed length). However, this spring force is disconnected from the cam follower 206, the axial cam 204, and ultimately the first portion and thus does not impart a rotational force between the first portion and the second portion. Second, the spring 218 is maintained in the compressed form by the trigger 212 blocking movement of the spring block 216 away from the spring 218. This maintains the spring 218 in the compressed form (e.g., delta between lengths L1 and L3). The compressed spring 218 stores potential energy that can subsequently be released when the spring is allowed to expand (e.g., return to length L1). The spring 218 is allowed to expand when the user acts on the trigger 212 to rotate the trigger clockwise until it disengages from the upper horizontal surface of the spring block 216. Example mechanisms that allow the user to act on the trigger 212 are described below relative to FIGS. 3A-3E and 4A-4M.

In the implementation illustrated in FIG. 2, the deployable link 208 provides a technical solution that physically couples the first and second portions 102 and 104 to the spring 218 under a first set of conditions. In this case, the first set of conditions include closing rotation of the first and second portions through a range of angles as the first and second portions are rotated in the closing direction but are not yet closed. The technical solution provided by the deployable link 208 decouples the first and second portions from the spring under a second set of conditions. In this case, the second set of conditions includes the first and second portions closing against one another. This technical solution isolates the spring force in the spine until such a time as device opening is desired.

FIGS. 3A-3E collectively show another hinge assembly 106C. A representative region of first portion 102 is shown relative to hinge shaft 202(1) and a representative region of second portion 104 is shown relative to hinge shaft 202(2). A synchronization element 302 synchronizes rotation of the first portion 102 to equal and simultaneous (opposite) rotation of the second portion 104. In this implementation, the synchronization element 302 is manifest as a relatively inelastic (e.g., non-elastic) cord, such as Dyneema, that is arranged in a figure-eight configuration around the hinge shafts 202. The non-elastic cord is secured to each of the hinge shafts to prevent slippage. Other implementations can employ other types of synchronization elements, such as intermeshing timing gears positioned relative to the first and second hinge shafts.

The hinge assembly 106C includes axial cams 204, cam followers 206, deployable links 208, triggers 212, spring blocks 216, springs 218, and releases 132. These elements are shown relative to the first portion 102 and hinge shaft 202(1) and second portion 104 and hinge shaft 202(2). However, to reduce clutter on the drawing page, these elements are labelled only relative to first portion 102 and hinge shaft 202(1).

FIG. 3A shows the first and second portions 102 and 104 at the 180-degree orientation. FIG. 3B shows the first and second portions 102 and 104 rotating in the closing direction (e.g., arrow CD) to the 90-degree orientation. FIG. 3C shows the first and second portions 102 and 104 closed to the zero-degree (e.g., closed) orientation. FIG. 3D shows the first and second portions 102 and 104 rotation in the opening direction (e.g., arrow OD) to the 90-degree orientation. FIG. 3E shows the first and second portions 102 and 104 opening to the 180-degree orientation.

In FIG. 3A at the 180-degree orientation, the first and second portions are parallel to one another and lie in a common reference plane. The deployable links 208 are positioned parallel or generally parallel to the hinge axes HA. The deployable links 208 are extending between, and physically touching, the cam followers 206 and the spring block 216. The springs 218 are uncompressed and are coupled to the first and second portions 102 and 104 via the spring blocks 216, deployable links 208, cam followers 206, and axial cams 204. At this point, the triggers 212 are adjacent to the spring blocks 216 and are not involved in the function of the hinge assembly 106C.

FIG. 3B shows each of the first and second portions 102 and 104 rotated in the closing direction towards one another about 45 degrees so that the angle between them is now about 90 degrees. The rotation of the first and second portions has rotated the axial cams 204, which in turn have forced the cam followers 206 downward in the −y reference direction. The deployable links 208 convey the downward movement of the cam followers 206 to the spring blocks 216, which are moved downward an equal distance. In turn, the spring blocks 216 encounter the springs 218. While not shown in this implementation, the springs 218 are prevented from moving downwardly. For instance, in the implementation of FIG. 2, the spring retainers 220 performed this function. At some point, the downward movement of the spring blocks 216 begins to compress the springs 218. This point can be in a range from about 90 degrees (e.g., as illustrated in FIG. 3B) to about 10 degrees, in various implementations.

In this implementation, the triggers 212 have a tapered profile that allows the triggers to gradually ride up onto the top surfaces of the spring blocks 216. In this case, the tapered profile includes a surface that is neither parallel to, nor perpendicular to, the top surface of the spring blocks 216. In the 90-degree orientation of FIG. 4B, the triggers 212 are just beginning to ride up on the spring blocks 216 due to the tapered profile. However, the triggers 212 are not physically engaging the deployable links 208.

FIG. 3C shows the first and second portions 102 and 104 rotated to the zero-degree (e.g., closed) orientation. At this point, the triggers 212 have pivoted and are over the upper surface of the spring blocks 216. The triggers 212 have also engaged the deployable links 208 and pushed (e.g., pivoted) the deployable links in the x reference direction until the deployable links 208 are no longer contacting the spring blocks 216. The spring blocks 216 are held in place by the triggers 212.

The springs 218 are in a compressed state after being compressed from the 90-degree orientation of FIG. 3B toward the zero-degree orientation of FIG. 3C. The springs 218 are pushing upwardly on the spring blocks 216 in the +y reference direction. However, the spring blocks 216 are retained (e.g., cannot move in the +y reference direction) by the triggers 212. Thus, the triggers 212 have both decoupled the spring force from the deployable links 208, cam followers 206, axial cams 204 and ultimately the first and second portions 102 and 104, and have retained the springs 218 in the compressed state, which stores potential energy. Thus, the spring force is now isolated in the hinge assembly and is not acting on the first and second portions.

FIG. 3D shows the state of the device after the user activates the releases 132. The releases 132 move (e.g., pivot) the deployable links 208 until the releases are parallel to the hinge axes (HA). In turn, the deployable links 208 move (e.g., pivot) the triggers 212 so that the triggers are no longer over the upper surfaces of the spring blocks. In this case, the tapered profile of the triggers allows them to gradually slide off of the spring blocks 216. As the triggers slide off of the spring blocks 216, the triggers no longer constrain movement of the spring blocks 216 in the +y reference direction. The springs 218 simultaneously move the spring blocks slightly upward in the y reference direction at which point the spring blocks 216 engage the deployable links 208. Recall that the deployable links 208 are now generally parallel to the y reference axis.

Contact between the spring blocks 216 and the deployable links 208 recouples the spring force from the compressed springs 218 to the cam followers 206, axial cams 204 and ultimately the first and second portions 102 and 104. The spring force (e.g., potential energy) stored in the compressed springs produces linear movement of the spring blocks 216, deployable links 208 and cam followers 206. The interaction of the cam followers 206 and the axial cams 204 converts the linear force into rotational force that rotates the first and second portions in an opening direction towards the 90-degree orientation shown in FIG. 4D. By this point, such as by 30 degrees, for instance, the springs 218 are decompressed and the user can readily continue to rotate the first and second portions to their desired orientation, such as the 180-degree orientation of FIG. 3E.

In this implementation, the releases 132, the deployable links 208, and the triggers 212 form the selective isolation assembly 222. The selective isolation assembly 222 provides the technical solution that allows the spring 218 to be compressed as the first and second portions 102 and 104 are closing, then disconnects the compressed spring 218 from the first and second portions when they approach and/or reach the closed orientation. The selective isolation assembly 222 allows the user to reconnect the compressed spring 218 to the first and second portions to provide a pop-up force to assist the user in opening the device. Thus, the pop-up force does not act continuously on the first and second portions and instead is only selectively applied to the first and second portions as desired.

FIGS. 4A-4M collectively show another example hinge assembly 106D positioned in device 100D. Some elements of hinge assembly 106D are similar to those introduced above relative to FIGS. 1A-3E and as such are not re-introduced here for sake of brevity. In this case, the deployable link 208 includes a first link 402 and a second link 404. Further, the spring block 216 is manifest as a spring coupler 406. The first link 402 is rotatably secured to the cam follower 206 by a pin, which is shown but not designated. The first link 402 and the second link 404 are rotatably secured together by a pin 408. The spring coupler 406 defines a channel 410. A pin 412 slideably secures the second link 404 in the channel 410. Housing 128(1) defines a slot 414 that receives pin 408. The slot 414 includes a first region 416 and a second region 418.

A slide 420 is positioned over the spring coupler 406. A slide spring 422 (FIG. 4B) is positioned between the user-controllable release 132 and the slide 420. The user-controllable release 132 is positioned against the slide 420. A button 424 is positioned external to the housing 128(1) and connected to the user-controllable release 132 by a transfer mechanism 426. In the illustrated configuration, the button 424 is positioned on the distal end 112 of the housing 128(1), but other locations are contemplated, such as on the spine 108.

FIG. 4B shows a portion of slide 420 separated along the xy reference plane and moved laterally in the x direction to show underlying elements including the slide's posts 428 and 430 that are positioned in channels 432 and 434 defined by the spring coupler 406. The channels 432 and 434 allow the posts 428 and 430, respectively, and hence the slide 420 to move in the x reference direction relative to the spring coupler 406, but constrain other movement.

FIGS. 4A-4C show the first and second portions 102 and 104 opened at about a 90-degree orientation. Three views are included to show the various elements. FIG. 4A is an overall perspective view of the device. FIG. 4B is a perspective view of a portion of the device. FIG. 4C is an elevational view that is similar to FIG. 4A. To avoid clutter on the drawing pages, the second portion 104 is shown on FIG. 4A and is removed on FIGS. 4B and 4C. At this point, the axial cam 204 is allowing the cam follower 206 to move fully to the left (e.g., −y reference direction) along the hinge axis (HA). Similarly, the deployable link 208, which is secured to the cam follower 206 is all the way to the left as is the spring coupler 406. The spring 218 is uncompressed.

FIGS. 4D-4M are similar views to FIG. 4C, but at different orientations. As with FIG. 4C, the second portion is not shown in these views to avoid obscuring the hinge assembly 106D.

FIG. 4D shows the device 100D with the first and second portions rotated toward one another to about a 45-degree orientation. The axial cam 204, which rotates with relative rotation between the first and second portions, has moved the cam follower 206 to the right (e.g., in the +y reference direction). Recall that the cam follower 206 cannot rotate around the hinge shaft 202. At this point, the closing rotation is rotating the axial cam 204, which is pushing the cam follower 206 to the right. In turn, the cam follower 206 is pushing the first link 402 of the deployable link 208 to the right. Note that a gap G exists between the cam follower 206 and the spring coupler 406. Thus, the cam follower 206 and the spring coupler 406 are not directly contacting one another but are interconnected by the deployable link 208.

The deployable link's pin 408 that extends between the first link 402 and the second link 404 is in the first region 416 of the slot 414. The first region 416 runs generally parallel to the hinge axis (such as within +/−10 degrees). The first region 416 prevents the pin 408 from moving downwardly (e.g., in the −x reference direction). As such, when the pin 408 is in the first region 416, the first link 402 and the second link 404 act as a single rigid structure and convey the force from the cam follower 206 through the deployable link 208 to the slide 420. Stated another way, when the pin 408 is in the first region 416, the deployable link 208 can move left to right in the y reference direction (e.g., along the hinge axis) but the length of the deployable link 208 is generally fixed in the y reference direction. Thus, force conveyed in the y reference direction by the cam follower 206 is transferred through the deployable link 208 to the slide 420. Specifically, the second link 404 is contacting a face 436 (e.g., a surface that is parallel to the xz reference plane) of the slide 420.

The slide 420 is retained relative to the spring coupler 406 by the posts 428 and 430 riding in channels 432 and 434, respectively. The post and channel relationship allows relative movement in the x reference direction between the slide 420 and the spring coupler 406 and constrains relative movement in the y reference direction. As such, the force imparted on the slide 420 in the y reference direction by the deployable link 208 is conveyed to the spring coupler 406. In turn, the spring coupler 406 conveys this force on the spring 218. Thus, relative to the orientation of FIG. 4C, in the orientation of FIG. 4D, the cam follower 206, deployable link 208, slide 420, and spring coupler 406 have all moved right (e.g., in the +y reference direction). The spring 218 is captive between the spring coupler 406 and the housing 128(1) and, as such, the movement of the spring coupler has compressed the spring 218. This is evidenced in that LDL2 that represents the length of the deployable link 208 is the same as LDL1 of FIG. 4C, but LDL2 is shifted right. Correspondingly, the length of the spring LS2 is shorter than LS1 in FIG. 4C (e.g., the spring is compressed in FIG. 4D).

FIG. 4E shows the device with the first and second portions rotated toward one another to about a 19-degree orientation. From the 45-degree orientation of FIG. 4D to the 19-degree orientation of FIG. 4E, the axial cam 204 continues to move the cam follower 206 to the right. This force was conveyed through the deployable link 208 to the spring 218 when the pin 408 was in the first region 416 of the slot 414. As such, the length LDL3 of the deployable link 208 is the same as the length LDL2 of FIG. 4D, but the deployable link is farther to the right. The spring 218 is further compressed such that length LS3 is shorter than LS2 of FIG. 4D.

In this implementation, the 19-degree orientation of FIG. 4E represents a transition where the pin 408 is leaving the first region 416 of slot 414 and entering the second region 418. The second region 418 extends generally in the x reference direction (such as within +/−10 degrees) and allows the pin 408 to move in the x reference direction by an extent defined by the slot 414. In this implementation, the second region 418 functions as the trigger 212. As the deployable link's pin 408 travels left to right in the first region 416, the deployable link 208 is in the first position where force is transferred from the cam follower 206 to compress the spring 218. When the pin 408 transitions to the second region 418, the deployable link 208 transitions to the second position where the deployable link disconnects the cam follower 206 from the spring 218. This aspect is described in more detail below.

FIG. 4F shows continued rotation of the first and second portions towards one another to the 4-degree orientation. During this rotation, the axial cam 204 is continuing to move the cam follower 206 to the right. In turn the cam follower 206 is pushing the first link 402 of the deployable link 208 to the right. However, pin 408 is now in second region 418 of the slot 414. The second region 418 allows pin 408 to move downwardly in the x reference direction (e.g., away from the hinge axis). Thus, even though the cam follower 206 moves right, the length LDL4 of the deployable link 208 decreased and thus did not impart this force on the spring 218 via the slide 420 and spring coupler 406. Thus, the length LS4 of the spring 218 is essentially the same as length LS3 of FIG. 4E.

Further, at this point as the pin 408 moves down the second region 418, the potential energy stored in the compressed spring can create a force on the second link 404 which pushes the pin 408 downwardly (e.g., away from the hinge axis). This downward force pulls the first link 402 of the deployable link 208 downward (e.g., pulls the proximal end of the first link 402 that is proximate to the pin 408 downward). The downward movement of the first link 402 pulls the cam follower 206 to the right (e.g., in the +y reference direction). Moving the cam follower 206 to the right pulls the axial cam 204 to the right. Pulling the axial cam to the right rotates the first and second portions towards one another. In some implementations, this reversed force (e.g., the spring force pulling on the cam follower rather than pushing on the cam follower) can finish closing the first and second portions against one another. In other implementations, the reverse force can make it easier for the user to finish closing the first and second portions against one another. As described in more detail below, this reverse force can be enabled by the deployable link 208, which can be viewed as functioning as a force reverser 438.

FIG. 4G shows the device after the first and second portions have continued to rotate towards one another to the zero-degree or closed orientation. From the four-degree orientation of FIG. 4F to the zero-degree orientation of FIG. 4G, the spring force pushed the pin 408 downward in the second region 418 of the slot 414 until in FIG. 4G the pin 408 is at the distal end of the second region 418. This downward movement of the pin 408 decreased the length LDL5 of the deployable link slightly relative to length LDL4 of the four-degree orientation of FIG. 4F. This movement from the spring force is evidenced in the spring length LS5 being slightly longer than the spring length LS4 of FIG. 4F. Stated another way, the spring 218 imparted a force that moved the spring coupler 406, which in turn moved slide 420 in the −y reference direction. The slide's face 436 contacts the second link 404 and moves the distal end of the second link 404 in the −y reference direction. The proximal ends of the first and second links and the pin 408 move downward as the spring 218 decompressed slightly. This movement causes the distal end of the first link 404 to pull the cam follower 206 to the right and makes closing the first and second portions the last few degrees easier than it would have otherwise been.

For a first subset of orientations from about 45 degrees to about 5 degrees, the deployable link 208 caused rotational energy from the first and second portions to compress the spring 218. This compression increased the rotational force (e.g., torque) used to rotate the first and second portions toward one another and stored potential energy in the compressed spring. However, in a second subset of orientations from about 5 degrees to zero degrees, the deployable link 208 uses some of the stored spring energy to aid in continued rotation by removing resistance and/or pulling the first and second portions together. As such, the deployable link 208 can be viewed as functioning as the reverser 438. In this case, the reverser 438 entails the first link 402, the second link 404, the pin 408, and the different paths provided for the pin 408 by the first region 416 and the second region 418 of the slot 414.

The pin 408 travels along the first region 416 for the first subset of orientations where the deployable link 208 is in a first position and travels in the second region 418 for the second subset of orientations where the deployable link is in a second position. In the first position, the first region 416 allows the cam follower 206 to push and compress the spring 218 through the deployable link. In the second position, the second region 418 allows the spring 218 to uncompress (e.g., lengthen) to force the pin 408 in the −x reference direction to cause the deployable link 208 to pull the cam follower 206 and thus the function and the force is ‘reversed.’

FIG. 4H shows the device 100D at the closed orientation as shown in FIG. 4G. However, the user wants to open the device and accordingly has engaged the button 424. In this case, the engagement involves moving the button in the +x reference direction. The button movement is transferred to the user-controllable release 132 by the transfer mechanism 426. From another perspective, the button 424 and the transfer mechanism 426 can be viewed as elements of the user-controllable release 132. The user-controllable release 132 has moved in the +x reference direction and contacted and moved the slide 420 in the +x reference direction to the extent allowed by the posts 428 and 430 sliding in the channels 432 and 434. In turn, the slide 420 compressed the slide spring 422 between the slide 420 and the spring coupler 406. (Some of these elements are only visible in FIG. 4B). The movement of the slide 420 in +x reference direction allows the distal end of the second link 404 to slip off of the face 436. The distal pin 412 of the second link 404 is now free to travel laterally (e.g., in the y reference direction) in the channel 410. As such, the distal end of the second link 404 can now slide parallel to the hinge axis (e.g., in the y reference direction) along the slide 420.

FIG. 4I shows the device still at the zero-degree or closed orientation as in FIG. 4H. However, with the distal end of the second link 404 now below the face 436 of the slide 420, pin 412 can move laterally in the channel 410. The spring coupler 406, which is against the compressed spring 218 can now be translated left (e.g., −y reference direction) by potential energy stored in the spring 218. This translation is evidenced in that the spring coupler 406 has moved left and closed gap G (e.g., there is no gap) and is now contacting the cam follower 206. The spring force is in turn translated through the cam follower 206 to the axial cam 204 where it is converted to rotational force (e.g., torque) to rotate the first and second portions away from one another. This is shown in FIG. 4J.

FIG. 4J shows the device portions have rotated open to about a 10-degree orientation due to spring force (e.g., pop-up force) conveyed from the compressed spring 218, through the spring coupler 406, to the cam follower 206, and finally the axial cam 204. Further, the leftward movement of the cam follower has pulled the first link 402 to the left and moved the pin 408 up the second region 418 of the slot 414.

FIG. 4K shows the device portions have continued to rotate open to about a 35-degree orientation due to spring force (e.g., pop-up force) conveyed from the compressed spring 218, through the spring coupler 406, to the cam follower 206, and the axial cam 204. Further, the leftward movement of the cam follower 206 has pulled the first link 402 to the left and moved the pin 408 left (e.g., in the −y reference direction) along the first region 416 of the slot 414.

FIG. 4L shows continued rotation of the device portions to about a 50-degree orientation. At this point, the spring coupler 406 is constrained from moving farther left (e.g., in the −y reference direction), such as by a stop, which is not shown. Stopping the spring coupler 406 stops translation of energy from the spring 218 to the cam follower 206 as the spring stops providing an opening (e.g., pop-up force) force. Further opening rotation can be provided by the user. As the user rotates the device farther open, the cam follower 206 and the spring coupler 406 will separate as evidenced by the return of the gap G in FIG. 4M.

FIG. 4M shows the device opened to about 90 degrees. With the continued rotation from 50 to 90 degrees, the cam follower 206 pulled the first link 402 to the left, which pulled the pin 408 to the left along the first region 416 of the slot 414. In turn, this pulled the second link 404 to the left and the pin 412 (FIG. 4A) moved left in channel 410 (FIG. 4A). At this orientation, the pin 412 moves far enough left in the channel 410 to allow the compressed slide spring 422 to move the slide 420 downward (e.g., in the −x reference direction) so the second link (e.g., pin 412) can slide onto face 436. The downward movement of the slide 420 will reset the user-controllable release 132 and force the button 424 back to its original position.

Thus, this implementation can provide a technical solution that utilizes rotational energy supplied by the user rotating the first and second portions towards one another to compress the spring 218 and store pop-up energy as potential energy in the spring. Further, the technical solution can decouple the pop-up energy from the first and second portions so that the pop-up energy is not operating on the first and second portions until opening of the device is desired (e.g., when the button 424 is depressed). Further, the technical solution can utilize some of the stored potential energy to pull the device portions toward one another the last few degrees to augment the closing process.

Implementations represented by FIGS. 4A-4M store energy captured from rotating device portions toward a closed orientation. Further, for a few degrees before reaching the closed orientation, some of the stored energy can be utilized to assist closing the device the last few degrees. Once closed, the remaining stored energy is decoupled from the first and second portions and isolated in the hinge assembly. This technical configuration enhances device function and longevity by reducing axial forces exerted on the device by a traditional configuration where the device portions are locked together to counter pop-up forces.

Individual elements of the hinge assemblies can be made from various materials, such as metals, plastics, and/or composites. These materials can be prepared in various ways, such as in the form of sheet metals, die cast metals, machined metals, 3D printed materials, molded or 3D printed plastics, and/or molded or 3D printed composites, among others, and/or any combination of these materials and/or preparations can be employed.

The present hinge assembly concepts can be utilized with any type of device, such as but not limited to notebook computers, smart phones, wearable smart devices, tablets, and/or other types of existing, developing, and/or yet to be developed devices.

Various methods of manufacture, assembly, and/or use for hinge assemblies and devices are contemplated beyond those shown above relative to FIGS. 1A-4M.

### Additional Examples

Various examples are described above. Additional examples are described below. One example includes a device comprising a first portion and a second portion that are rotatably secured relative to a hinge axis through a range of rotation from an open orientation to a closed orientation, a deployable link that in a first position extends between the first portion and a spring to allow compression of the spring as the first portion and the second portion are rotated toward the closed orientation, and a trigger that is both configured to transition the deployable link to a second position that decouples the first and second portions from the compressed spring and to retain the spring compression.

Another example can include any of the above and/or below examples where the trigger directly blocks the spring from decompressing.

Another example can include any of the above and/or below examples where the trigger acts on another component that blocks the spring from decompressing.

Another example can include any of the above and/or below examples where the other component comprises a selective isolation assembly that blocks the compressed spring from creating an opening force on the first and second portions.

Another example can include any of the above and/or below examples where the selective isolation assembly reverses force from the compressed spring to facilitate rotation of the first and second portions to the closed orientation.

Another example can include any of the above and/or below examples where the hinge axis comprises a first hinge axis that the first portion rotates around and further comprising a second hinge axis that the second portion rotates around.

Another example can include any of the above and/or below examples where the device further comprises a synchronizing element that is configured to synchronize rotation of the first portion around the first hinge axis with equal and simultaneous rotation of the second portion around the second hinge axis.

Another example can include any of the above and/or below examples where the spring is coextensive with the first hinge axis and further comprising a second spring coextensive with the second hinge axis and a second trigger associated with the second hinge axis.

Another example can include any of the above and/or below examples where the device further comprises a release that is configured to be engaged by a user to cause the deployable link to move the trigger and reconnect the spring force to the first portion.

Another example can include any of the above and/or below examples where the deployable link, the trigger, and the release are all located on a spine of the device.

Another example includes a device comprising a first portion and a second portion that are rotatably secured through a range of rotation from an open orientation to a closed orientation and a selective isolation assembly configured to convert rotational torque associated with rotating the first and second portions toward the closed orientation to a compressive force that compresses a spring, the selective isolation assembly configured to disconnect the first and second portions and the compressed spring as the first and second portions approach the closed orientation.

Another example can include any of the above and/or below examples where the selective isolation assembly comprises a deployable link and a trigger.

Another example can include any of the above and/or below examples where the deployable link mechanically couples the first and/or second portions to the spring in a first position and the trigger moves the deployable link to a second position that decouples the first and/or second portions from the spring.

Another example can include any of the above and/or below examples where the trigger retains the compressed spring when moving the deployable link to the second position and prevents decompression of the compressed spring.

Another example can include any of the above and/or below examples where the selective isolation assembly further comprises a reverser that is configured to use force from the compressed spring to close the first and second portions against one another.

Another example can include any of the above and/or below examples where the selective isolation assembly further comprises a release that when activated by a user is configured to physically cause the trigger to release the spring compression.

Another example can include any of the above and/or below examples where the release is configured to physically move the deployable link back to the first position and disengage the trigger from the compressed spring.

Another example includes a device comprising a first portion and a second portion that are rotatably secured relative to a hinge axis through a range of rotation from an open orientation to a closed orientation, a deployable link that in a first position extends between the first portion and a spring to allow compression of the spring by the first portion and the second portion rotating toward the closed orientation, and a trigger that transitions the deployable link to a second position that decouples the first portion and the compressed spring and retains the spring compression.

Another example can include any of the above and/or below examples where the trigger physically moves the deployable link from the first position to the second position and retains the compressed spring.

Another example can include any of the above and/or below examples where the device further comprises a user-controllable release that physically moves the deployable link back to the first position and disengages the trigger from the compressed spring.

Although techniques, methods, devices, systems, etc., pertaining to hinge assemblies are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

1. A device, comprising:
a first portion and a second portion that are rotatably secured relative to a hinge axis through a range of rotation from an open orientation to a closed orientation;
a deployable link that in a first position extends between the first portion and a spring to allow compression of the spring as the first portion and the second portion are rotated toward the closed orientation; and,
a trigger that is both configured to transition the deployable link to a second position that decouples the first and second portions from the compressed spring and to retain the spring compression.

2. The device of claim 1, wherein the trigger directly blocks the spring from decompressing.

3. The device of claim 1, wherein the trigger acts on another component that blocks the spring from decompressing.

4. The device of claim 3, wherein the other component comprises a selective isolation assembly that blocks the compressed spring from creating an opening force on the first and second portions.

5. The device of claim 4, wherein the selective isolation assembly reverses force from the compressed spring to facilitate rotation of the first and second portions to the closed orientation.

6. The device of claim 1, wherein the hinge axis comprises a first hinge axis that the first portion rotates around and further comprising a second hinge axis that the second portion rotates around.

7. The device of claim 6, further comprising a synchronizing element that is configured to synchronize rotation of the first portion around the first hinge axis with equal and simultaneous rotation of the second portion around the second hinge axis.

8. The device of claim 6, wherein the spring is coextensive with the first hinge axis and further comprising a second spring coextensive with the second hinge axis and a second trigger associated with the second hinge axis.

9. The device of claim 1, further comprising a release that is configured to be engaged by a user to cause the deployable link to move the trigger and reconnect the spring force to the first portion.

10. The device of claim 9, wherein the deployable link, the trigger, and the release are all located on a spine of the device.

11. A device, comprising:
a first portion and a second portion that are rotatably secured through a range of rotation from an open orientation to a closed orientation; and,
a selective isolation assembly configured to convert rotational torque associated with rotating the first and second portions toward the closed orientation to a compressive force that compresses a spring, the selective isolation assembly configured to disconnect the first and second portions and the compressed spring as the first and second portions approach the closed orientation.

12. The device of claim 11, wherein the selective isolation assembly comprises a deployable link and a trigger.

13. The device of claim 12, wherein the deployable link mechanically couples the first and/or second portions to the spring in a first position and the trigger moves the deployable link to a second position that decouples the first and/or second portions from the spring.

14. The device of claim 13, wherein the trigger retains the compressed spring when moving the deployable link to the second position and prevents decompression of the compressed spring.

15. The device of claim 14, wherein the selective isolation assembly further comprises a reverser that is configured to use force from the compressed spring to close the first and second portions against one another.

16. The device of claim 14, wherein the selective isolation assembly further comprises a release that when activated by a user is configured to physically cause the trigger to release the spring compression.

17. The device of claim 16, wherein the release is configured to physically move the deployable link back to the first position and disengage the trigger from the compressed spring.

18. A device, comprising:
a first portion and a second portion that are rotatably secured relative to a hinge axis through a range of rotation from an open orientation to a closed orientation;
a deployable link that in a first position extends between the first portion and a spring to allow compression of the spring by the first portion and the second portion rotating toward the closed orientation; and,
a trigger that transitions the deployable link to a second position that decouples the first portion and the compressed spring and retains the spring compression.

19. The device of claim 18, wherein the trigger physically moves the deployable link from the first position to the second position and retains the compressed spring.

20. The device of claim 19, further comprising a user-controllable release that physically moves the deployable link back to the first position and disengages the trigger from the compressed spring.
